(19) United States
(12) Patent Application Publication
(10) Pub. No.: US 2008/0294575 A1
(43) Pub. Date: Nov. 27, 2008

(54) System for Providing Widget-Type Idle-screen Contents Data Providing System for Mobile Communication Terminal

(75) Inventor: Hoon Jung, Yongin-si (KR)

Correspondence Address: INTELLECTUAL PROPERTY LAW GROUP LLP, 12 SOUTH FIRST STREET, SUITE 1205, SAN JOSE, CA, 95113, US

(73) Assignee: MINIGATE CO. LTD., Seoul (KR)

(21) Appl. No.: 12/014,077

(22) Filed: Jan. 14, 2008

(30) Foreign Application Priority Data
May 22, 2007 (KR) 10-2007-0049924

(51) Int. Cl. G06Q 99/00; G06F 7/06; G06F 17/30

(52) U.S. Cl. 705/400; 707/5; 707/E17.014

(57) ABSTRACT

A system for providing a widget-type idle-screen contents data is provided. The system includes a data generation unit which generates the widget-type idle-screen contents data for the mobile communication terminal; a contents database which receives the widget-type idle-screen contents data from the data generation unit and stores and manages the widget-type idle-screen contents data; and a mobile communication terminal which selectively downloads the contents data from the contents data and stores and operates the downloaded contents data, wherein, the mobile communication terminal comprises a firmware level, an OEM level, an idle-screen platform, a porting layer, a base layer, and an application layer.

### CROSS-REFERENCE TO RELATED PATENT APPLICATION

This application claims the benefit of Korean Patent Application No. 10-2007-0049924, filed on May 22, 2007, in the Korean Intellectual Property Office, the disclosure of which is incorporated herein in its entirety by reference.

### BACKGROUND OF THE INVENTION

1. Field of the Invention

The present invention relates to a system for providing a widget-type idle-screen contents data for a mobile communication terminal, and more particularly, to a system for providing a widget-type idle-screen contents data for a mobile communication terminal capable of providing various contents and enhancing esthetics by using the idle-screen of the mobile communication terminal using the widget-type idle-screen contents.

2. Description of the Related Art

As the rapid development of information technology (IT) environments, the Internet and mobile communication have been essential parts in modern life.

In particular, since the mobile communication technology has been developed in a form of integration of various state-of-the-arts technologies, various new industrial fields are created, and enormous added values are created.

Most people carry at least one mobile communication terminals such as a cellular phone. The market for mobile communication terminals and the market for value-added services have been rapidly expanded. As representative examples of the value-added services for the mobile communication terminal, there are a ring tone service, a ringback tone service, an idle-screen graphic contents service, and the like.

However, in case of the idle-screen graphic contents service among the aforementioned services, the contents data downloaded from the contents provider cannot be moved, edited, and rearranged. In addition, a plurality of the contents data cannot be easily applied at the same time. Therefore, the idle-screen graphic contents service cannot satisfy user's demands for configuring more special idle-screens.

Accordingly, there is a need for a new technique for providing the idle-screen contents data for a mobile communication terminal, in which a user can edit and arrange various contents according to user's preference.

### SUMMARY OF THE INVENTION

An object of the present invention is to provide a system for providing a widget-type idle-screen contents data for a mobile communication terminal, capable of providing various contents and enhancing esthetics by using idle-screen contents on an idle screen of the mobile communication terminal.

The present invention is not limited to the aforementioned object, but the other objects of the present invention will be clearly understood through the following detailed description by those skilled in the art.

According to an aspect of the present invention, there is provided a system for providing a widget-type idle-screen contents data for a mobile communication terminal, comprising: a data generation unit which generates the widget-type idle-screen contents data for the mobile communication terminal; a contents database which receives the widget-type idle-screen contents data from the data generation unit and stores and manages the widget-type idle-screen contents data; and a mobile communication terminal which selectively downloads the contents data from the contents data and stores and operates the down loaded contents data, wherein, the mobile communication terminal comprises a firmware level, an OEM level, an idle-screen platform, a porting layer, a base layer, and an application layer.

In the above aspect of the present invention, the operation or management of the downloaded widget-type idle-screen contents data may be performed on the idle-screen platform.

In addition, the widget-type idle-screen contents data providing system may further include a fee calculation unit generating billing information corresponding to the download widget-type idle-screen contents data. In addition, the fee calculation unit may generate fee information on the data generation unit corresponding to the download widget-type idle-screen contents data.

In addition, data transmission between the contents database and the mobile communication terminal may be performed in an XML data transmission scheme.

Other details of the aspect of the present invention are disclosed in the detailed description and the accompanying drawings.

### BRIEF DESCRIPTION OF THE DRAWINGS

The above and other aspects of the present invention will become more apparent by describing in detail exemplary embodiments thereof with reference to the attached drawings in which:

FIG. 1 is a schematic view illustrating a configuration of a system for providing a widget-type idle-screen contents data for a mobile communication terminal according to an embodiment of the present invention;

FIG. 2 is a detailed view illustrating software configuration layers of the mobile communication terminal of FIG. 1; and

FIG. 3 is a view illustrating an example of an idle screen of the mobile communication terminal to which the widget-type idle-screen contents data according to the embodiment is applied.

### DETAILED DESCRIPTION OF THE INVENTION

The advantages and features, and the method of the present invention will become more apparent by referring to following exemplary embodiments described in detail along with the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the specification, like reference numerals denotes like elements.

Hereinafter, embodiments of the present invention will be described in detail with reference to the accompanying drawings.

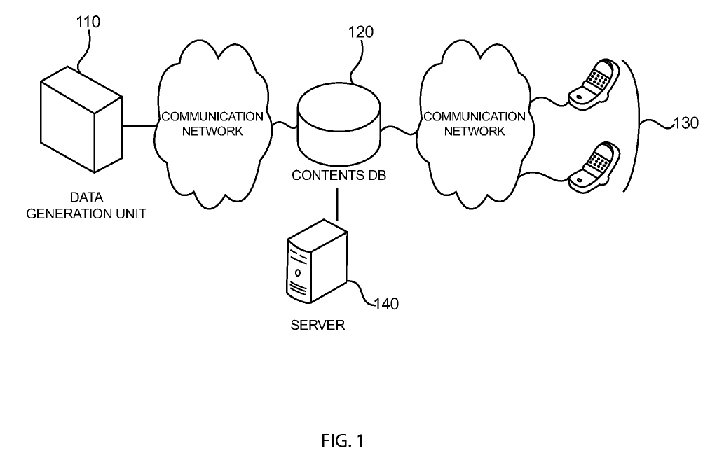

FIG. 1 is a schematic view illustrating a system for providing widget-type idle-screen contents data of a mobile communication terminal according to an embodiment of the present invention.

As shown in FIG. 1, the system for providing a widget-type idle-screen contents data of a mobile communication terminal includes a data generation unit 110, a contents database 120, a mobile communication terminal 130, a fee calculation server 140, and the like.

The data generation unit 110 can be constructed with a data generation computer and the like of a contents provider (CP) or a person such as a programmer who uploads his/her programs.

The data generated by the data generation unit 110 are the widget-type idle-screen contents applicable to an idle-screen of the mobile communication terminal 130.

The term “widget” refers to a small graphic user interface (GUI) tool which operates an application program on an operating system (OS) installed on a system such as a computer and displays a result of the operation on a screen.

In other words, the widget denotes a small window which displays information transmitted via the internet. Due to the widget, various functions such as a clock, a calendar, a memo, a search, a map, news, and a real-time camera that have been provided in a browser such as the Internet explorer can be operated without execution of the browser.

In this manner, the widget-type idle-screen contents data generated by the data generation unit 110 can be transmitted to the contents database 120 using various wire/wireless communication schemes. Preferably, in the present invention, an XML data transmission scheme such as a multipurpose internet mail extension (MIME) scheme and an SMTP/MIME (S/MIME) scheme may be used.

In the MIME scheme, a text is transformed according to a base-64 encoding scheme for a binary data. Therefore, since error check for compressed binary data, for example, in a “zip” or “rar” compression format can be performed through a base-64 encoding scheme, it is possible to reduce an amount of transmission data and efficiently manage the transmission data.

The S/MIME scheme is an extension MIME scheme based on an SMTP protocol. In the S/MIME scheme, several additional data are attached to the MIME format, and the additional data are also transmitted.

However, it will be apparent to those skilled in the art that the present invention is not limited to the aforementioned schemes.

The contents database 120 stores and manages the widget-type idle-screen contents data generated by the data generation unit 110 and transmitted in the XML data transmission scheme.

Namely, if the contents data are transmitted from the data generation unit 110, the contents database 120 can perform functions of classifying and storing the contents into categories according to an appropriate classification rule in consideration of user's convenience and the like and generating and providing a list of stored data.

The contents database 120 may perform a predetermined function of evaluating and selecting the contents data transmitted from the data generation unit 100. In other words, all the contents data transmitted from the data generation unit 110 are not stored and managed. Firstly, evaluation items such as esthetics and user's convenience of the contents data are evaluated according to internal criteria. After that, only the contents data of which evaluation results are greater than some level can be stored and managed by the contents database 120.

The mobile communication terminal 130 is a personal terminal such as a mobile phone. The mobile communication terminal 130 selectively downloads the contents data from the contents database 120 and stores or operates the contents data.

In the embodiment of the present invention, the mobile communication terminal 130 applied to the system for providing a widget-type contents data includes a firmware level, an OEM level, an idle-screen platform, a porting layer, a base layer, and an application layer.

The contents data downloaded from the contents database 120 may be operated on the idle-screen platform of the mobile communication terminal 130.

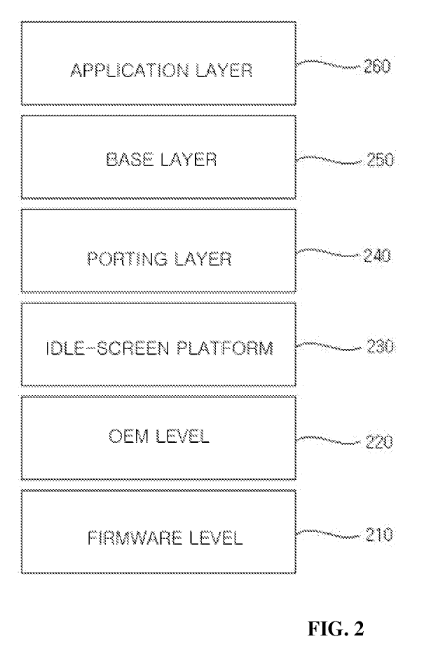

The aforementioned embodiment will be described in detail with reference to FIG. 2.

The server 140 may be further provided so as to control input and output of the contents data of the contents database 120.

More specifically, the server 140 may include a billing function for the contents data downloaded from the contents database 120 to each mobile communication terminal 130 or a fee-calculating function for the contents data uploaded from the data generation unit 110.

Although a fee-calculating method for the contents data uploaded from the data generation unit 110 is varied according to a configuration of the system, a fee-calculating method in which a fee is increased or decreased so as to correspond to details of downloading of the user's mobile communication terminal 130. However, the present invention is not limited to the aforementioned billing and fee-calculating methods. It will be apparent to those skilled in the art that any billing and fee-calculating methods can be modified and employed.

In addition, it should be noted that the server 140 can be configured to perform a normal system-management task such as user information management.

FIG. 2 is a detailed view illustrating software configuration layers of the mobile communication terminal of FIG. 1.

Referring to FIG. 2, the software configuration layers of the mobile communication terminal applied to a user-interface providing system for the mobile communication terminal according to the embodiment of the present invention includes a firmware level 210, an OEM level 220, an idle-screen platform 230, a porting layer 240, a base layer 250, and an application layer 260.

The firmware level 210 is configured by a manufacturer of the mobile communication terminal. In the firmware level 210, a function for connecting an operation of a hardware chip with an associated application programming interface (API) is performed.

The OEM level 220 is associated with an operating system of the mobile communication terminal. In the OEM level, WIPI (Wireless Internet Platform for Interoperability), BREW (Binary Runtime Environment for Wireless), Symbian, Java, and the like are operated.

The idle-screen platform 230 is a Web 2.0-based mobile management platform, which is configured in accordance with SyncML protocol so as to be easily operated in the foregoing legacy system.

The porting layer 240 performs a function of allowing application programs for GUI or other value-added services to be applied to the mobile communication terminal.

In the base layer 250, a function for normalizing and modulating the API is performed so as for the application programs for the GUI or other value-added services to use the OEM lever ported by the porting layer 240.

In the application layer 260, a function such as idle-screen decoration and ring-tone management according to user's preference is performed by directly operating the widget-type idle-screen contents data supported in the idle-screen platform 230.

A cache process in the idle-screen platform 230 can be performed in a manner similar to a general cache process applied to music streaming and the like. In addition, as described above, the XML-based information can be used for internal-data management and data transmission and reception of the mobile communication terminal.

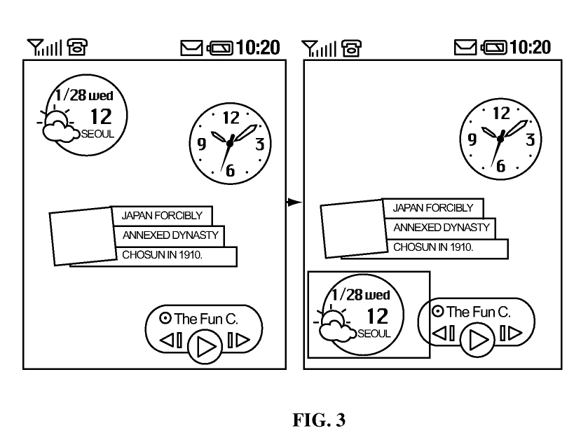

FIG. 3 is a view illustrating an example of an idle screen of the mobile communication terminal to which the widget-type idle-screen contents data according to the embodiment is applied.

As shown in FIG. 3, the widget-type idle-screen contents (weather information, a clock, news, a music player, and the like) can be added, deleted, edited, moved, or color-changed according to user's preference.

As described above, according to the present invention, in a system for providing a widget-type idle-screen contents data, a user can freely edit and arrange various contents by easily adding, deleting, and moving the idle-screen contents of the mobile communication terminal, so that the user can configure the mobile communication terminal in various manners according to user's preference.

In addition, since the widget-type idle screen can be provided, various functions such as effective animation function, image transformation or combination, and GUI editing function can be performed.

In addition, costs and time for development of user interfaces are greatly reduced, and various modifications can be obtained from one content. Therefore, it is possible to maximize applicability of developed contents.

While the present invention has been particularly shown and described with reference to the attached drawings and exemplary embodiments thereof, it will be understood by those skilled in the art that various changes in form may be specifically made therein without departing from the spirit and essential features. Therefore, the aforementioned embodiments are only exemplary ones, but it should not be understood that the present invention is limited thereto.

I claim:

1. A system for providing a widget-type idle-screen contents data for a mobile communication terminal, comprising:
a data generation unit which generates the widget-type idle-screen contents data for the mobile communication terminal;
a contents database which receives the widget-type idle-screen contents data from the data generation unit and stores and manages the widget-type idle-screen contents data; and
a mobile communication terminal which selectively downloads the contents data from the contents database and stores or operates the downloaded contents data,
wherein, the mobile communication terminal comprises a firmware level, an OEM level, an idle-screen platform, a porting layer, a base layer, and an application layer.

2. The system of claim 1, wherein the operation or management of the widget-type idle-screen contents data is performed on the idle-screen platform.

3. The system of claim 1, further comprising a fee calculation unit generating billing information corresponding to the download widget-type idle-screen contents data.

4. The system of claim 3, wherein the fee calculation unit generates fee information on the data generation unit corresponding to the downloaded widget-type idle-screen contents data.

5. The system of claim 3, wherein data transmission between the contents database and the mobile communication terminal is performed in an XML data transmission scheme.

6. The system of claim 2, further comprising a fee calculation unit generating billing information corresponding to the download widget-type idle-screen contents data.

7. The system of claim 6, wherein the fee calculation unit generates fee information on the data generation unit corresponding to the downloaded widget-type idle-screen contents data.

8. The system of claim 6, wherein data transmission between the contents database and the mobile communication terminal is performed in an XML data transmission scheme.
